(19) United States
(12) Patent Application Publication
(10) Pub. No.: US 2008/0077686 A1
(43) Pub. Date: Mar. 27, 2008

(54) System and Method for Replication of Network State for Transparent Recovery of Network Connections

(76) Inventor: Dinesh Kumar Subhraveti, Milpitas, CA (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/535,117

(22) Filed: Sep. 26, 2006

(51) Int. Cl. G06F 17/30; G06F 15/173

(52) U.S. Cl. 709/224; 707/8; 709/223

(57) ABSTRACT

A system and method for replication of network state for transparent recovery of network connections are provided. The system and method avoid having to identify and intercept the internal non-deterministic events of a network stack by adopting a state-capture approach. This state-capture approach views the network state of the primary and replica application instances from the viewpoint of an external client. In this way, only network state changes of the primary application instance that are communicated to an external client need to be replicated at the replica application instance. Other network state changes, e.g., internal network state changes, that are not communicated to the external client need not be replicated at the replica application instance. In other words, the illustrative embodiments permit differences in internal network state for those network states that are not made public to the external world, i.e. outside the application instance.

### BACKGROUND

1. Technical Field

The present application relates generally to an improved data processing system and method. More specifically, the present application is directed to a system and method for replication of network state data for transparent recovery of network connections.

2. Description of Related Art

Service downtime is one of the major reasons for revenue loss in modern network based enterprises. This problem is often addressed by providing redundancy in the enterprise systems. With such redundancy, the state of a running application is mirrored by a set of one or more replica applications running on one or more different data processing systems. In the event of a failure, one of the replica applications takes over the running of the application instance in such a way that the failure is not externally visible, i.e. to the users of the application. The service as a whole remains available and continues to run without interruption, as long as not all instances, i.e. replicas, of the application fail at the same time.

An application can be viewed as a black box which produces a set of outputs based on a set of inputs. The state of the application consists of the state associated with the individual resources that the application uses, such as processor register contexts, memory pages, network sockets, etc. The operating system provides a simplified view of the system resources such that some of their state is not directly visible to the application and is internally maintained by the operating system on the application's behalf.

In order to provide failover from the primary application instance to a replica application instance, it is necessary to keep this portion of kernel state, i.e. the portion the application state maintained by the operating system, synchronized between the primary and replica application instances so that when a replica application instance takes over for a primary application instance, the replica application instance perceives a consistent operating system kernel state. This can be difficult when attempting to synchronize state changes due to non-deterministic events. Because of their non-deterministic nature, replaying or performing the same non-deterministic operations and generating the same non-deterministic events or values on two or more different instances of an application does not guarantee that the same result is obtained. This may be especially troublesome with regard to network state where the network protocol requires consistency in order to facilitate communication between computing devices.

### SUMMARY

The illustrative embodiments provide a system and method for replication of network state data for transparent recovery of network connections. The mechanisms of the illustrative embodiments log network state information for system calls and other internal processes at the primary application instance so that the network state may be replicated at a replica application instance. Only network state information for network state changes that are communicated outside of the primary application instance is logged. Network state changes that are not communicated outside of the primary application instance need not be replicated at the replica application instance.

The logged network state information is provided to a replica application instance in response to the detection of an outbound external communication at a socket of the primary application instance. The logged network state information may be provided to the replica prior to, or at substantially the same time as, the outbound external communication is permitted to be sent. Thus, the outbound external communication operates as a trigger for sending the logged network state information from the primary application instance to the replica application instance.

At the replica application instance, which is executing in parallel with the primary application instance but on a different data processing device, the logged network state information is used to return data to system calls performed by the replica application instance. That is, system calls made by the replica application instance are intercepted and return data from corresponding system calls made by the primary application instance are returned to the replica application instance. In this way, the state of the replica application instance is synchronized with that of the primary application instance.

With the mechanisms of the illustrative embodiments, since only the network state information that is perceivable to an external network and network attached devices is logged and provided to the replica application instance, differences in the state of the network stacks for the primary and replica application instances may be permitted. It is only the network state expected, by external network attached devices, to be present in the application instance that is of importance to performing switchover from the primary application instance to the replica application instance, such as in response to a failure of the primary application instance. Such an approach is made possible by viewing the network state from the viewpoint of an external network or network attached client device. With such an approach, a simple and efficient implementation of a fault tolerance system is made possible by obviating the need to log network packets.

In one illustrative embodiment, a computer program product comprising a computer useable medium having computer executable instructions embodied therein is provided. The computer executable instructions, when executed in a data processing system, cause the data processing system to initialize a log data structure associated with a primary application instance running on a first computing device and log network state information associated with the primary application instance in the log data structure. The computer executable instructions further cause the data processing system to detect an outgoing external communication from the primary application instance to one or more external devices external to the first computing device. In response to detecting the outgoing external communication, the computer executable instructions cause the data processing system to transmit the logged network state information from the first computing device to a second computing device running a replica application instance. In the event of a failure of the primary application instance, the replica application instance recovers for the primary application instance using a replica application instance network state made consistent with a network state of the primary application instance prior to the failure, based on the logged network state information.

The network state information logged in the log data structure may comprise only network state information required to make a network state of the replica application instance consistent with a network state of the primary application instance communicated to one or more external devices. Other network state information, associated with a network stack of the primary application instance, which is not communicated to the one or more external devices is not logged in the log data structure.

Moreover, the logged network state information may comprise data returned in response to one or more network state associated system calls by the primary application instance. Furthermore, the logged network state information may comprise cumulative network state information recorded from a point in time of a previous outbound external communication up to a point in time where a current outbound external communication is to be performed by the primary application instance.

The computer executable instructions may cause the data processing system to log network state information by logging data returned by network state associated system calls in the log data structure until the outbound external communication is detected at the socket of the primary application instance. Moreover, in response to detecting the outbound external communication at the socket of the primary application instance, network stack state information associated with the socket of the primary application instance may be logged.

The computer executable instructions may cause the data processing system to transmit the logged network state information by transmitting the log data structure to the second computing device either prior to permitting the outbound external communication to occur or at substantially a same time as the outbound external communication occurs.

The computer executable instructions may further cause the data processing system to receive, at the second computing device, the logged network state information from the first computing device and update a network state of the replica application instance based on the logged network state information received from the first computing device. The updating of the network state of the replica application instance is performed such that the network state of the replica application instance is consistent with a network state of the primary application instance communicated to the one or more external devices, in order to provide transparent recovery of the primary application instance by the replica application instance.

The computer executable instructions may further cause the data processing system to intercept, by the second computing device, system calls invoked by the replica application instance and satisfy the invoked system calls using data provided in the logged network state information received from the first computing device. The data in the logged network state information may be associated with corresponding system calls invoked by the primary application instance.

The computer executable instructions may further cause the data processing system to detect a failure of the primary application instance and perform a switchover operation to switchover handling of requests by the one or more external devices to the replica application instance in response to detecting the failure of the primary application instance. By virtue of satisfying the invoked system calls using data provided in the logged network state information received from the first computing device, the replica application instance has a network state consistent with the network state of the primary application instance communicated to the one or more external devices.

In a further illustrative embodiment, a computer program product may be provided wherein the computer executable instructions embodied in the computer readable medium of the computer program product cause a data processing system to receive, from a computing device executing a primary application instance, a log data structure, the log data structure storing only network state information required to make a network state of a replica application instance consistent with a network state of the primary application instance communicated to one or more external devices. The computer executable instructions may further cause the data processing system to update a network state of the replica application instance based on the network state information in the log data structure. Moreover, the computer executable instructions may further cause the data processing system to recover for the primary application instance in the event of a failure of the primary application instance. At the time of failure, the network state of replica application instance is consistent with the network state of the primary application instance communicated to the one or more external devices by way of the updating of the network state of the replica application instance based on the network state information in the log data structure.

In yet another illustrative embodiment, a method for replication a network state of a primary application instance, running on a first computing device, at a replica application instance running on a second computing device is provided. The method may comprise initializing a log data structure associated with the primary application instance running on the first computing device and logging network state information associated with the primary application instance in the log data structure. The method may further comprise detecting an outgoing external communication from the primary application instance to one or more external devices external to the first computing device. The method may also comprise transmitting, in response to detecting the outgoing external communication, the logged network state information from the first computing device to the second computing device running the replica application instance. In the event of a failure of the primary application instance, the replica application instance recovers for the primary application instance using a replica application instance network state made consistent with a network state of the primary application instance prior to the failure, based on the logged network state information.

The network state information logged in the log data structure may comprises only network state information required to make a network state of the replica application instance consistent with a network state of the primary application instance communicated to one or more external devices. Other network state information, associated with a network stack of the primary application instance, that is not communicated to the one or more external devices may not be logged in the log data structure.

The logged network state information may comprise data returned in response to one or more network state associated system calls by the primary application instance. Moreover, the logged network state information comprise cumulative network state information recorded from a point in time of a previous outbound external communication up to a point in time where a current outbound external communication is to be performed by the primary application instance.

Logging network state information may comprise logging data returned by network state associated system calls in the log data structure until the outbound external communication is detected at the socket of the primary application instance. Moreover, logging network state information may comprise logging, in response to detecting the outbound external communication at the socket of the primary application instance, network stack state information associated with the socket of the primary application instance.

Transmitting the logged network state information may comprise transmitting the log data structure to the second computing device either prior to permitting the outbound external communication to occur or at substantially a same time as the outbound external communication occurs.

The method may further comprise receiving, at the second computing device, the logged network state information from the first computing device and updating a network state of the replica application instance based on the logged network state information received from the first computing device. The updating may be performed such that the network state of the replica application instance is consistent with a network state of the primary application instance communicated to the one or more external devices, in order to provide transparent recovery of the primary application instance by the replica application instance.

The method may further comprise intercepting, by the second computing device, system calls invoked by the replica application instance. The invoked system calls may be satisfied using data provided in the logged network state information received from the first computing device, the data being associated with corresponding system calls invoked by the primary application instance.

The method may further comprise detecting a failure of the primary application instance and performing a switchover operation to switchover handling of requests by the one or more external devices to the replica application instance in response to detecting the failure of the primary application instance. By virtue of satisfying the invoked system calls using data provided in the logged network state information received from the first computing device, the replica application instance has a network state consistent with the network state of the primary application instance communicated to the one or more external devices.

In yet another illustrative embodiment, an apparatus is provided. The apparatus may comprise a processor and a memory coupled to the processor. The memory may comprise instructions which, when executed by the processor, cause the processor to perform various ones, and combinations of, the operations outlined above with regard to the method illustrative embodiment.

These and other features and advantages of the present invention will be described in, or will become apparent to those of ordinary skill in the art in view of, the following detailed description of the exemplary embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an exemplary block diagram of a distributed data processing system in accordance with one illustrative embodiment;

FIG. 2 is an exemplary block diagram of a data processing device that may be a client or server computing device in accordance with one illustrative embodiment;

FIG. 3 is an exemplary diagram illustrating an operation of one illustrative embodiment;

FIG. 4 is an exemplary block diagram of a primary application instance's primary fault tolerance engine in accordance with one illustrative embodiment;

FIG. 5 is an exemplary block diagram of a replica fault tolerance engine in accordance with one illustrative embodiment;

FIG. 6 is a flowchart outlining an exemplary operation of a primary fault tolerance engine in accordance with one illustrative embodiment; and

FIG. 7 is a flowchart outlining an exemplary operation of a replica fault tolerance engine in accordance with one illustrative embodiment.

### DETAILED DESCRIPTION OF THE ILLUSTRATIVE EMBODIMENTS

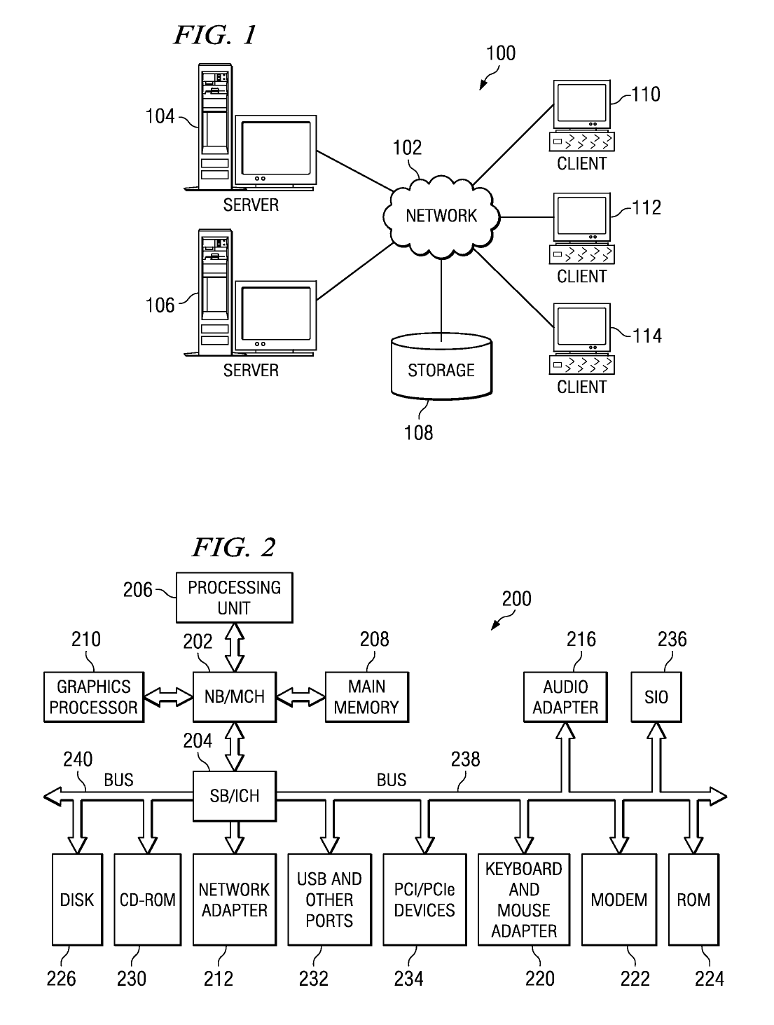

The illustrative embodiments provide a mechanism by which replication of network state is made possible in order to enable transparent recovery of network connections. Because the mechanisms of the illustrative embodiments are primarily directed to recovery of network connections in terms of switchover or failover of a primary application instance to one of the replica application instances, the illustrative embodiments are especially well suited for implementation in a distributed data processing system comprising one or more communication networks. Thus, FIGS. 1 and 2 hereafter are provided as examples of a distributed data processing system and data processing devices in which exemplary aspects of the illustrative embodiments may be implemented. It should be appreciated that FIGS. 1-2 are only exemplary and are not intended to state or imply any limitation with regard to the types of, or configurations of, data processing environments and data processing devices that may be used with the mechanisms of the illustrative embodiments.

With reference now to the figures, FIG. 1 depicts a pictorial representation of an exemplary distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

With reference now to FIG. 2, a block diagram of an exemplary data processing system is shown in which aspects of the illustrative embodiments may be implemented. Data processing system 200 is an example of a computer, such as hosts 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

Referring again to FIG. 1, server 104 may provide a primary application instance with which client devices 110, 112, and 114 communicate to obtain various services, information, or functionality. Server 106 may provide a replica application instance that is used to provide redundancy of the primary application instance so as to minimize service downtime experienced by the client devices 110, 112, and 114. The replica application instance may execute on the server 106 substantially in parallel with the execution of the primary application instance on server 104 such that both application instances initiate substantially the same system calls, internal operations, external communications, and the like. When an event occurs, such as the primary application instance on server 104 failing or the like, a switchover operation may be performed in order to switchover handling of communication with client devices 110, 112, and 114 to the replica application instance provided by server 106.

It should be appreciated that while FIG. 1 illustrates servers 104 and 106 being separate from one another and only accessible by one another via network 102, the illustrative embodiments are not limited to such a configuration. To the contrary, servers 104 and 106 may be part of a same server cluster, may be connected to one another via a local area network, or the like. For example, the servers 104 and 106 may be part of a server cluster in which each of the servers 104 and 106 is directly connected to each other.

Moreover, the primary and replica application instances referenced in the present description may even be provided on the same server computing device, such as in different logical partitions. For purposes of this description, however, it will be assumed that servers 104 and 106 are topographically remotely located from one another on the network 102. Being topographically remotely located from one another on network 102 may mean that the servers 104 and 106 are also geographically remotely located, although this is not necessary. To the contrary, the servers 104 may be geographically local to one another but, within the virtual topography of the network 102, may be topographically remote from one another.

Preferably, application storage state information is maintained consistent between the primary application instance and the replica application instance. For example, application storage state information may be mirrored between the server 104 and the server 106. Possible mechanisms for performing such mirroring are described in commonly assigned and co-pending U.S. patent application Ser. No. 11/340,813 filed Jan. 25, 2006, entitled “System and Method for Relocating Running Applications to Topologically Remotely Located Computing Systems” and U.S. patent application Ser. No. 11/403,050 filed Apr. 12, 2006, entitled “System and Method for Application Fault Tolerance and Recovery Using Topologically Remotely Located Computing Devices,” which are hereby incorporated by reference. In addition, in accordance with the illustrative embodiments described herein, network state information is maintained consistent between the primary application instance on server 104 and the replica application instance on server 106 with regard to the network state made public to client devices 110, 112, and 114.

The mechanisms of the illustrative embodiments log network state information for system calls and other internal operations of the primary application instance, so that the network state may be replicated at the replica application instance on server 106. Network state changes that are not communicated outside of the primary application instance on server 104 are not logged since it is not necessary that these changes be replicated at the replica application instance on server 106. Such an approach is made possible by viewing the network state from the viewpoint of an external network or network attached client device, e.g., client devices 110, 112, and 114.

In order to provide transparent switchover of a primary application instance to a replica application instance, it is important that the network state information maintained by the operating system kernel associated with the primary application instance be replicated at the replica application instance. That is, the operating system kernel can be viewed as an extension of the application. Parts of the operating system kernel's state need to be synchronized, just as the application's state is synchronized, so that the switchover from the primary application instance to the replica application instance is transparent to the external world. However, it is not necessary to explicitly log every piece of state that the operating system kernel maintains on behalf of the application. In some cases, the operating system kernel state is automatically synchronized due to the deterministic behavior of the application and the operating system.

For example, when the primary application instance opens a file, the operating system kernel populates the internal file table with the file descriptor corresponding to the opened file. This internal operating system kernel data structure does not have to be explicitly replicated because there is no non-determinism involved in the process of its creation. When the replica application instance, tracing the execution path of the primary application instance, eventually opens the same file, the operating system kernel hosting the replica application instance would populate the file table in the same way.

However, the internal state of the network stack is a result of a complex and non-deterministic interaction between application instance on one side, and the external network on the other side. One approach to synchronizing the network states of primary and replica application instances is to track the non-deterministic events within the primary application instance's network protocol stack and replay their results to the replica application instance's network protocol stack.

The non-determinism within the network protocol stack can originate from many different sources. For instance, in transport protocols, such as TCP, the random choice of sequence numbers for messages and random port numbers assigned to unbound sockets when a connect system call is issued introduces non-determinism. These cases are handled by recording the initial sequence numbers and port numbers and replaying them at the network protocol stack of the replica application instance.

However, other sources of non-determinism within the network protocol stack are more difficult to handle. In particular, the interleaved order of messages received and sent by the network protocol stack has to be preserved to ensure that the state of the network protocol stack at the primary and replica application instances is identically populated. Recording the messages entering the network protocol stack from the network and replaying them at the replica application instance is difficult in practice.

To illustrate this, consider the active-open case of connection establishment in TCP where the primary application instance opens a network connection with a remote client. In this case, according to the protocol, a synchronization-acknowledgement (syn-ack) message is the first packet that is recorded as it is the first message that the network protocol stack receives. If this packet is delivered to the network protocol stack at the replica application instance before it sends out the corresponding synchronization (syn) segment, the syn-ack packet that has been delivered to the network protocol stack at the replica application instance will be rejected.

This behavior is exhibited not only during connection establishment, but generally through TCP communication. That is, TCP, like other network communication protocols, cannot accept a message that it does not expect to receive. Furthermore, TCP is sensitive to the actual times at which the messages are received. TCP computes round-trip-time (RTT) statistics based on these times and uses them in congestion control, etc. If the timing attributes of the messages are not accurate, TCP's behavior may become inconsistent with respect to the remote clients and may result in a deadlock or loss of a connection.

The mechanisms of the illustrative embodiments utilize a state-capture approach with regard to the network state of the primary application instance and replica application instance. With the state-capture approach, the network state of the replica application instance is viewed from the viewpoint of an external client device, e.g., client devices 110, 112, and 114, and only the network state changes that have been made public to, i.e. communicated to, the client devices 110, 112, and 114, or those network state changes submitted by the external client devices 110, 112, and 114 and have been acknowledged by the primary application instance on server 104, are captured and replicated at the replica application instance on server 106. Other network state changes, e.g., internal network state changes which have not been communicated to the external client devices 110, 112, and 114, need not be replicated at the replica application instance. In other words, the illustrative embodiments permit differences in internal network state for those network states that are not made public to the external world, i.e. outside the primary application instance on server 104.

The ability to take such an approach to maintaining consistency of network state between the primary application instance on server 104 and the replica application instance on server 106 is predicated on the observation that, for switchover or failover, the important concern is to make sure that the network state of the replica application instance on server 106 is consistent with the network state of the primary application instance on server 104 expected to be seen by the external client devices 110, 112, and 114. Those events occurring with regard to the primary application instance and which cause network state changes that have not been made apparent to the external client devices 110, 112, and 114, from the viewpoint of the external client devices 110, 112, and 114, have not occurred. Those non-deterministic events causing network state changes submitted by the client devices 110, 112, and 114, but which have not been acknowledged by the primary application instance will be resubmitted by the client devices 110, 112, and 114. If a switchover event occurs prior to such acknowledgement, the resubmission by the client devices 110, 112, and 114 will be received by the replica application instance and the network state will be updated accordingly at the replica application instance's network stack.

To illustrate this point, assume that a client device 110 requests that a socket connection be established for communication between the client device 110 and the primary application instance on server 104. If the socket connection is created at the primary application instance on server 104, but the socket information has not been provided to the client computing device, as far as the client computing device is concerned, no socket connection has been established. Thus, if the replica application instance on server 106 takes over for the primary application instance on server 104, the client computing device will simply resend its request to the replica application instance. The replica application instance may generate a completely different socket connection with the client device than was originally created by the primary application instance, but this does not matter since the client device never “saw” the original socket connection generated by the primary application instance. Hence, to the client device, it is as if the socket connection generated by the replica application instance was the only socket connection ever created in response to its request.

Thus, it is not necessary to record, in a log, every network stack operation performed so that it may be replayed at the replica application instance. To the contrary, only those network stack operations that cause a change in network stack state that is then communicated to the external world, e.g., the external network or network attached client devices, need to be recorded and replayed at the replica application instance server so as to maintain the replica application instance's network stack consistent with the state of the primary application instance's network stack that is known to the external world.

In response to an event requiring the replica application instance to take over handling of client requests for the primary application instance, in order to achieve a transparent switchover from the primary application instance on server 104 to the replica application instance on server 106, for example, the replica application instance's network stack, i.e. the particular software implementation of a computer networking protocol suite, should return identical data to the replica application instance as the primary application instance's network stack returns to the primary application instance.

Network services are made available to the application through a set of well defined system calls of a system interface. The primary and replica application instances exclusively use this system interface to interface with one or more communication networks. For the replica application instance to precisely follow the execution of the primary application instance, the return values and other data returned by these system calls should be identical to corresponding invocations of those system calls on the primary application instance. The data returned to the replica application instance should match that returned to the primary application instance, regardless of whether the internal state of the network stack reflects the returned data.

The illustrative embodiments herein meet this requirement by intercepting a replica application instance's system calls to the application instance's network stack. In other words, only the primary application instance on server 104, for example, is permitted to access the network 102 through system calls to the primary application instance's network stack while system calls to the replica application instance's network stack on server 106 are intercepted.

For intercepted system calls to the replica application instance's network stack on server 106, rather than obtaining the response data from the network 102 or client devices 110, 112, or 114 via the network 102, the data is returned to the replica application instance's network stack from a log data structure associated with the primary application instance on server 104. For example, if the replica application instance issues a socket write system call, the illustrative embodiments return the value returned by a corresponding socket write system call made by the primary application instance even though no data from the replica application instance is actually sent out on the network. This value is returned from a log entry of the socket write system call made by the primary application instance.

Before the switchover event, the outbound network messages generated by the replica application instance are filtered out in the network stack. That is, only the primary application instance on server 104 is permitted to interact with the external world via the one or more networks 102 while outbound network messages by the replica application instance on server 106 are discarded. Since the state of the replica application instance's network stack does not have any influence on the external world, i.e. since the replica application instance cannot communicate with the external world, before the switchover, it is permissible to have a difference in internal state of the replica application instance's network stack with that of the primary application instance's network stack.

However, the state of the replica application instance's network stack must be consistent with previously published messages to the external world by the primary application instance. That is, if the replica application instance on server 106 were to take over for the primary application instance on server 104, the replica application instance's network state should not disagree with what external client devices 110, 112, and 114 would expect its state to be based on previously communicated messages to/from the external client devices 110, 112, and 114 by the primary application instance on server 104. Changes to the state of the primary application instance's network stack do not have to be propagated to the replica application instance's network stack as long as they are not externally communicated. The external messages include outbound network messages, messages written to consoles, or any other form of irreversible external communication.

In order to ensure that network stack state changes associated with messages communicated to the external world are replicated at the replica application instance's network stack, the illustrative embodiments gather state information from the network stack at the primary application instance on server 104 and add this state information to the log data structure containing data, such as the return values of the system calls and results of other nondeterministic events. This log data structure is communicated from the primary application instance to the replica application instance and committed to the replica application instance before every outbound external communication made by the primary application instance.

The various pieces of state information that are committed to the replica may include sequence numbers, time stamp values, timer states and their values, window parameters, acknowledged data in receive buffers associated with the primary application instance, and the like. The data in the send queue associated with the replica application instance is automatically populated as the replica application instance follows the execution of the primary application instance and writes the same data into the sockets as the primary application instance. Thus, the send queues are automatically made consistent through the consistent execution of the replica and primary application instances and thus, the data in the send queues need not be logged by the primary application instance and communicated to the replica application instance. Data in the messages that have been received by the primary application instance's network stack but not yet acknowledged does not have to be recorded in the log of the primary application instance because such messages would be resent by the remote client and, in the resending, provided to the replica application instance following a switchover event.

By logging system calls in the above manner, the system calls of the replica application instance are virtualized. This virtualization is needed only until a switchover from the primary application instance to the replica application instance occurs. After the switchover is complete, the replica application instance's network stack takes over for the primary application instance's network stack and further virtualization is not necessary, i.e. system calls to the replica application instance's network stack are permitted to access the network after the switchover is completed.

The network stack of the underlying operating system is typically shared by all the processes running in a system. However, only the state corresponding to the network sockets of the primary application instance are captured and logged. The illustrative embodiments' container abstraction creates an isolated view of the network subsystem by assigning a private IP address and port namespace, which the application within the container uses. Only the state associated with the sockets bound to the container's IP address is logged. Both the primary and replica application instances use the same IP address. However, this does not cause a problem since, by the mechanisms of the illustrative embodiments, only the primary application instance's data packets are sent out over the one or more networks while the replica application instance's data packets are intercepted until a switchover event occurs.

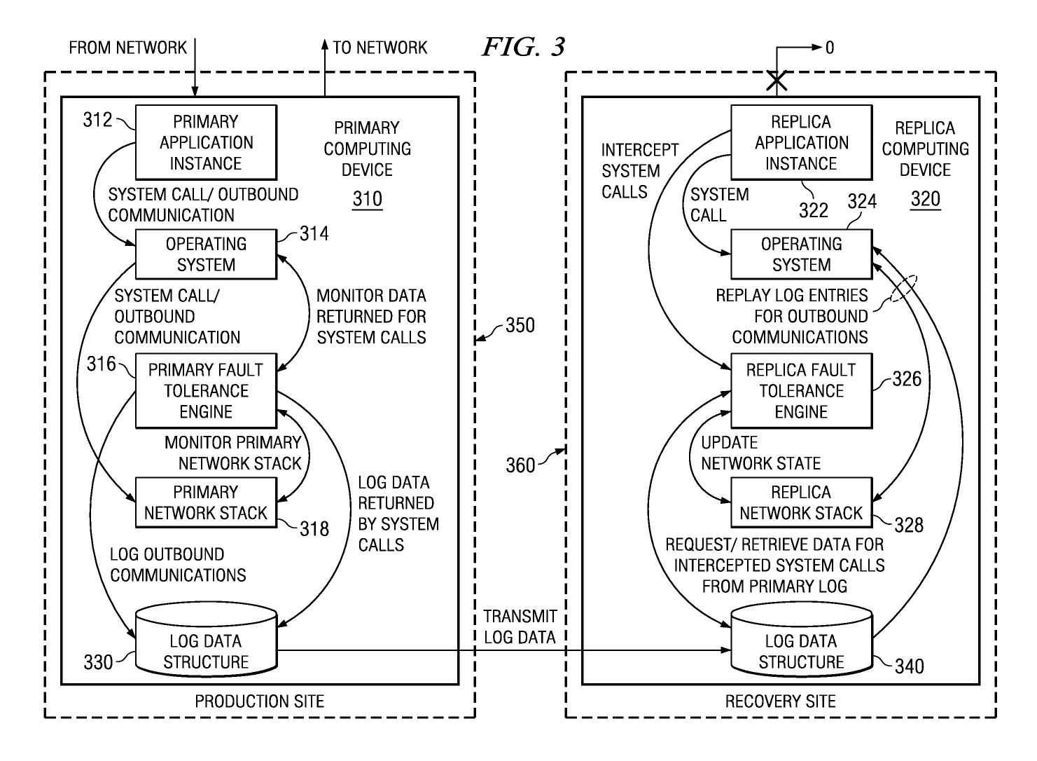

FIG. 3 is an exemplary diagram illustrating an operation of one illustrative embodiment. As shown in FIG. 3, a primary computing device 310 is provided at a production site 350 and an active replica computing device 320 is provided at a recovery site 360. The recovery site 360 may be topologically (with regard to the network topology) and/or geographically remotely located from the production site 350. Alternatively, the production site 350 and recovery site 360 may be local to one another, such as in a server cluster in which the primary computing device 310 and the replica computing device 320 are directly connected to each other via a local area network. Moreover, the production site 350 and recovery site 360 may be at a same geographic location and may be local to one another from a network topology standpoint.

The primary computing device 310 has an associated operating system 314, a primary fault tolerance engine 316, a primary network stack 318, and a log data structure 330. The primary network stack 318 provides a software implementation of a network protocol suite through which communications with an external network may be performed. The primary network stack 318 has a state that needs to be replicated, to a degree that the state is known to external client devices, at the recovery site 360.

The log data structure 330, in concert with the operating system 314 and primary fault tolerance engine 316, logs network stack state information data corresponding to events that cause changes in state of the primary network stack 318. For example, network stack state information, e.g., timestamps, sequence numbers, timer states and values, window parameters, etc., may be logged in response to external communications performed by or received by the primary application instance 312. Moreover, data returned by system calls made by the primary application instance 312 may be logged in the log data structure 330. Thus, the log data structure 330 does not log all events and data that cause changes to the primary network stack state but only those state changes that are communicated to the external world, i.e. associated with outbound external communications (external to the primary application instance). Moreover, the log data structure 330 also logs data returned to the primary application instance 312 in response to a system call by the primary application instance 312.

In operation, the log data structure 330 logs data returned in response to system calls by the primary application instance 312 until an outbound external communication is to be performed. In response to detecting an outbound external communication at a socket of the primary application instance, network stack state information, e.g., timestamps, sequence numbers, etc., is added to the log data structure 330 and the log data structure 330 is communicated to, and committed at, the recovery site 360. Such communication and commitment may include populating the log data structure 340 at the replica site 360 with information from the log data structure 330 at the production site 350. The log data structure 330 may then be cleared and logging of data may continue until the next outbound external communication. In this way, the log data structure 330 may maintain the data corresponding to network state changes occurring between outbound external communications. Alternatively, the log data structure 330 may be cumulative and may not be cleared with each communication of the log data structure 330 to the replica site 360.

When the log data structure 330 is provided to the recovery site 360, the data corresponding to data returned by system calls by the primary application instance 312 may be returned from the log data structure 340 to the replica application instance 322 for corresponding system calls made by the replica application instance. Other network state information may be used to update the state of the network stack of the replica application instance 322.

It should be noted that, with regard to the outbound external communication, the occurrence of the outbound external communication is only used as a cue or trigger to synchronize the network state with the replica. The content of the outbound external communication need not be logged since, with regard to the network stack of the replica application instance, it is only the occurrence of the outbound external communication and its change on network state that is of importance. Moreover, it should be noted that the logged data structure 330 is committed at the replica site 360, meaning that receipt of the log data structure at the replica site 360 is ensured, e.g., by an acknowledgment or non-acknowledgment mechanism. Thus, with the mechanisms of the illustrative embodiments, when an outbound external communication is about to occur, the cumulative state of the network stack of the primary application instance 312 is synchronized with the replica application instance 322. This state is a result of incoming messages that may have been received by the network stack and several internal operations, e.g., system calls, associated with the network stack.

The log data structure 330 may be associated with the primary application instance 312, for example, by way of an identifier associated with the primary application instance 312. For example, this identifier may be an Internet Protocol (IP) address associated with the primary application instance 312. Both the primary application instance 312 and the replica application instance 322 utilize a same IP address but outbound communications by the replica application instance 322 are barred by the replica computing device 320. Thus, the log data structure 330 may be associated with the replica application instance 322 when the log data structure 330 is transmitted to the replica site 360 and is used to populate log data structure 340.

The primary computing device 310 includes the primary fault tolerance engine 316 that is responsible for performing operations in accordance with the illustrative embodiments with regard to the primary computing device 310. The active replica computing device 320 includes a replica fault tolerance engine 324 that is responsible for performing operations in accordance with the illustrative embodiments with regard to the active replica computing device 320.

In operation, the primary application instance 312 operates in a normal fashion by accepting requests from external client devices, generating outbound external communications to external devices, performing system calls, and generally handling processing of client device requests as is generally known in the art. As part of this normal operation of the primary application instance 312, the primary application instance 312 may make various system calls and generate outbound external communications. As the replica application instance 322 traces the same path of execution as the primary application instance 312, the replica application instance 322 performs identical system calls and generates identical outbound external communications.

The mechanisms of the illustrative embodiments ensure that the replica application instance 322 receives the same data returned by its system calls as the primary application instance receives from its system calls. The mechanisms of the illustrative embodiments further gather network stack state information in response to detecting outbound external communications performed by the primary application instance 312 and provide this network stack state information to the replica application instance 322 to thereby update the replica application instance's network stack state to be consistent with the network stack state of the primary application instance 312 expected by external devices.

With regard to the mechanisms of the illustrative embodiments, the primary fault tolerance engine 316 and the replica fault tolerance engine 326 operate to virtualize the network protocol application program interface (API) so as to maintain network state between the primary and replica application instances in a consistent state with regard to the state communicated to the external devices. This virtualization involves the primary fault tolerance engine 316 logging data corresponding to system calls and internal operations of the primary application instance 312 as well as network stack state information in response to the occurrence of an outbound external communication. The virtualization further involves the replica fault tolerance engine 326 intercepting system calls by the replica application instance 322 and returning data from the log data structure 330 of the primary application instance 312 to the replica application instance's network stack 328 instead of communicating with the external network and network attached clients.

In order to illustrate the manner by which such virtualization is performed, an example implementation will be described with regard to the Transport Control Protocol (TCP) generally used in communications over the Internet. It should be appreciated that the following example implementation is only an example and is not intended to state or imply any limitation with regard to the mechanisms of the illustrative embodiments. Rather, other implementations of the illustrative embodiments may involve other operations in addition to, or in replacement of, those operations set forth hereafter and may be used with TCP or with other communication protocols and APIs.

The example implementation for virtualization of TCP API will be described with regard to the system calls that may be performed with regard to the TCP API, e.g., Read, Bind, Connect, Accept, Listen, Select, and Write. With regard to the Read system call, socket reads are intercepted by the replica fault tolerance engine 326. Data returned by a corresponding socket read system call performed by the primary application instance 312 is logged into the log data structure 330 of the production site 350 and is communicated and committed to the replica application instance 322 at the next external communication. In this way, Read system calls from the replica application instance 322 are satisfied from the log data structure.

With regard to the Bind system call, both the primary application instance 312 and the replica application instance 322 utilize the same virtual IP address. As mentioned above, this will not cause an address conflict because only one of the two application instances 312, 322 is operational with regard to the external network and network attached clients at any time. Thus, there are no external communications by the replica application instance 322 when performing the Bind system call until it takes over operation for the primary application instance 312. As a result, the replica application instance 322 may safely execute the Bind system call to bind sockets to the virtual IP address.

Regarding the Connect system call, i.e. the system call for active open connection establishment, when the primary application instance 312 performs a Connect system call, the local port and initial sequence number are logged in the log data structure 330. As described previously, in response to the primary application instance 312 performing an outbound external communication, at substantially the same time as the outbound external communication, this log data structure 330 is updated with network stack state information, such as timestamp values, timer states and values, window parameters, sequence numbers, etc., and is communicated and committed to the replica application instance 322.

When the replica application instance 322 makes a corresponding Connect system call, the local port and initial sequence number logged in the log data structure 330 are provided to the replica application instance's network stack 328 thereby forcing the replica application instance's network stack 328 to use the same port number and initial sequence number. A synchronization packet may actually be generated by the replica application instance 322 and may serve as a mirrored copy of the corresponding synchronization packet of the primary application instance 312 in case the primary application instance 312 fails.

At this point, the socket associated with the replica application instance 312 is in a synchronization sent state. When the corresponding socket on the primary application instance 312 enters a TCP established state with the final outbound acknowledge packet, the TCP state of the socket is synchronized with the replica application instance 322. As a consequence, the socket state of the replica application instance 322 jumps from a synchronization sent state directly to a TCP established state. This does not affect the consistency of the application instance or the ability to recover from a potential failure during the connection establishment phase. To illustrate this, imagine that the primary application instance 312 fails after receiving the synchronization acknowledgement packet from the remote client device but before sending the final acknowledgement packet. When the replica application instance 322 takes over for the primary application instance 312, the socket of the replica application instance 322 is in a synchronization sent state and the TCP stack would not notice anything inconsistent when the remote client device resends the synchronization acknowledgement packet. Rather, the replica application instance 322 gracefully responds with an acknowledgement packet and the connection is established with the replica application instance 322.

With regard to the Accept system call, i.e. the system call for passive open connection establishment, when a primary application instance's network stack 318 responds to a synchronization packet from a remote client device with a synchronization acknowledgement packet, the corresponding entry in the listen queue is recorded and committed to the replica application instance 322. This ensures that the replica application instance 322 may take over for the primary application instance 312 in the case of a failure thereafter.

Eventually, when the remote client device sends an acknowledgement packet in response to the synchronization acknowledgement, the socket of the primary application instance 312 is placed in an accept queue in the form of a minisock. At this point, there is an apparent discrepancy of state between the primary application instance 312 and the replica application instance 322 but this will not affect the ability of the replica application instance 322 to take over for the primary application instance 312 in the case of a failure. When the primary application instance 312 calls the Accept system call, and the minisock is dequeued, the state of the minisock is captured in the log data structure 330 and eventually sent over to the replica application instance 322. When the replica application instance 322 calls the Accept system call, the minisock is restored using the captured minisock state information in the log data structure 330.

With regard to the Listen system call, similar to the Bind system call, listen also does not involve any external communication and thus, there is no virtualization needed for this on standby. Regarding the Select system call, the return values, e.g., the file descriptors and their status, is logged and replayed using the mechanisms of the illustrative embodiments. With regard to the Write system call, as in the case of the Read system call, the return values of Write system calls are logged in the primary application instance's log data structure 330. The state of the replica application instance's network stack 328 is refreshed from the primary application instance's log data structure 330 before running the socket write system call.

As discussed above, a crucial set of network state information items are captured and committed to the replica application instance 322 before the occurrence of an outbound external communication. These information items are generally of a non-deterministic type, i.e., the values of these information items may be different for independent operation of the primary and replica application instances. For example, sequence numbers, time stamps, timer states and values, and window parameters are all captured network state items in accordance with the illustrative embodiments. The mechanisms of the illustrative embodiments capture sequence numbers because, using TCP as an example, the sequence numbers are tracked by TCP for determining the next byte to be sent, the next byte that is expected to be received, etc. If this information is not maintained across a switchover from the primary application instance 312 to the replica application instance 322, the external client devices may detect an inconsistent behavior and the connection with the external client devices may become “broken.”

Time stamps are captured because, for example, TCP uses round trip time (RTT) measurements to help tune various parameters that govern TCP's response to changing traffic patterns. RTT statistics have to be replicated between the primary and replica application instances for smooth flow of TCP traffic after a switchover event.

Timer values are captured because, for example, a primary application instance 312 may enable a timer after the last time that TCP state information was captured. For example, TCP maintains four timers: a retransmit timer, a delay acknowledgement timer, a keepalive timer, and a time_wait timer. It is possible that TCP may enable one of these timers after TCP state information was captured. The timeout values have to be adjusted according to the new values on the primary application instance 312 in order to ensure proper operation of the replica application instance 322.

Window parameter information is captured because, for example, during the course of a connection, TCP may update the estimated window size of the remote client device and the estimated network congestion along the connection route. It is important for these parameters to be accurate at a switchover event because they control whether the next packet can be sent or not. Any apparent discrepancy between the window parameter information of the primary application instance 312 and the replica application instance 322 could potentially cause the connection with the remote client device to become deadlocked.

To further illustrate the operation of the illustrative embodiments, consider an example of a TCP server using POSIX sockets and implementing the mechanisms of the illustrative embodiments previously described. It is assumed that the following sequence of events occur:

(1) the application instance creates a socket;

(2) the application instance binds the socket to a desired port and IP address;

(3) the application instance places the socket in a listen mode;

(4) the application instance waits for a connection to arrive by calling the Accept system call;

(5) the TCP stack receives a synchronization segment on the socket;

(6) the TCP stack creates a synchronization acknowledgement segment and populates it with a randomly generated sequence number, the timestamp, etc.; and

(7) the synchronization acknowledgement packet is sent out to the remote client device.

The first four steps above are performed by the server application instance and are deterministic in nature. They prepare the data structures required to accept external connections. When a replica application instance goes through the same steps, corresponding data structures are created in the same manner. Even though each of these four steps changes the state of the TCP stack on the primary application instance, those changes do not have to be committed to the replica application instance. If the primary application instance fails during these steps, the replica application instance can recover by deterministically executing the same steps.

Steps 5 and 6 are non-deterministic. That is, if the TCP stack at the replica application instance goes through these steps, it is unlikely that the same network state results. However, until step 7 is performed, the results of this non-determinism are not communicated to the external world. If the primary node fails after step 6, but before step 7, the replica application instance can still transparently recover. The replica application instance will potentially generate a different sequence number but this choice does not affect the external client devices. However, once a synchronization acknowledgement packet with a specific sequence number is sent out, the replica application instance cannot recover unless it knows the sequence number and other TCP state.

If a failure of the primary application instance occurs after step 5, the synchronization segment received by the TCP stack would be lost. In this case, the replica application instance would recover to a state prior to the receipt of the synchronization segment. However, since the primary application instance has not sent an acknowledgement, the remote client device's TCP stack would resend the synchronization segment. It is assumed that the fault is detected, and switchover is triggered, before the remote client device times out and closes the connection.

Thus, the mechanisms of the illustrative embodiments ensure a successful switchover from a primary application instance to a replica application instance, such as in response to a failure of the primary application instance. Successful switchover is ensured by (1) virtualizing the network interface with the application instance such that the data returned to the application is derived directly from the log coming from the primary application instance; and (2) capturing portions of network state information which are a result of non-deterministic operations and committing them to the replica application instance immediately before the occurrence of each external communication. Such switchover from the primary application instance to the replica application instance is performed in a transparent manner such that the client devices do not perceive the switchover event.

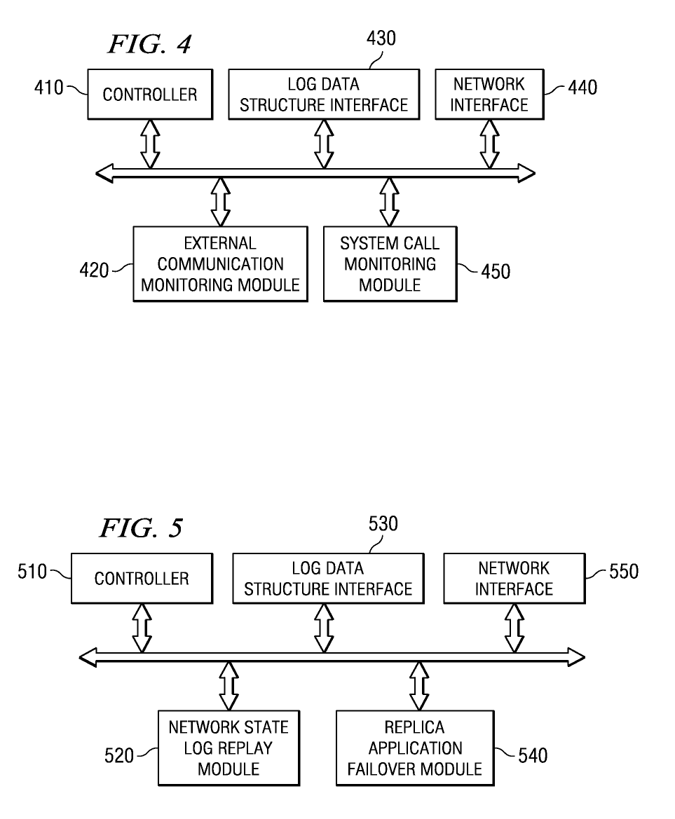

FIG. 4 is an exemplary block diagram of a primary application instance's primary fault tolerance engine in accordance with one illustrative embodiment. As shown in FIG. 4, the primary fault tolerance engine includes a controller 410, an external communication monitoring module 420, a log data structure interface 430, a network interface 440, and a system call monitoring module 450. The elements 410-450 may be implemented as software, hardware, or any combination of software and hardware. For example, in one illustrative embodiment, the elements 410-450 are implemented as software instructions executed by one or more data processing devices.

The controller 410 controls the overall operation of the primary fault tolerance engine and orchestrates the operation of the other elements 420-450. The external communication monitoring module 420 monitors the sockets of application instances for outgoing external communications. Network stack state information is logged, in response to detecting the outgoing external communication, in a log data structure accessible before such communication via the log data structure interface 430.

The system call monitoring module 450 extracts data from responses to system calls. The extracted data is logged in a log data structure via the log data structure interface 430. The log information stored in the log data structure based on the monitoring of the sockets and system calls is used to update a log data structure at a replica application instance so as to ensure transparent switchover from a primary application instance to the replica application instance in the event of a failure of the primary application instance, or the like.

In operation, the system call monitoring module 450 monitors responses to system calls by the primary application instance and logs the data returned by these system calls. This continues until the external communication monitoring module 420 detects an outgoing external communication at a socket. In response to the detection of the outgoing external communication, the network stack state information is logged in the log data structure and the outgoing external communication is permitted to occur. Moreover, in response to the logging of the network stack state information, the controller 410 transmits the log data structure, via the network interface 440, to a replica site. The transmission of the log data structure to the replica site may occur prior to the permitting of the outgoing external communication to occur or at substantially the same time as the outgoing external communication is permitted to occur.

FIG. 5 is an exemplary block diagram of a replica fault tolerance engine in accordance with one illustrative embodiment. As shown in FIG. 5, the replica fault tolerance engine includes a controller 510, a network state log replay module 520, a storage system interface 530, a replica application failover module 540, and a network interface 550. The elements 510-550 may be implemented as software, hardware, or any combination of software and hardware. For example, in one illustrative embodiment, the elements 510-550 are implemented as software instructions executed by one or more data processing devices.

The controller 510 controls the overall operation of the replica fault tolerance engine and orchestrates the operation of the other elements 520-550. The network interface 540 provides an interface over which the log data may be received and stored in a local log data structure via storage system interface 530.

The network state log replay module 520 replays log events and provides log data to a replica application instance so as to make the network stack state consistent with a primary application instance's network stack. The network state log replay module 520, for example, provides log data in response to system calls by the replica application instance rather than allowing the replica application instance to access the external network and communicate with external client devices. Moreover, network stack state information, e.g., sequence numbers, timer values, etc., associated with the socket of the primary application instance is provided to the replica application instance so as to update the network stack state of the replica application instance to be consistent with a network stack state expected to be seen by external client devices.

The storage system interface 530 provides an interface through which a log data structure associated with the replica application instance may be accessed. The replica application failover module 540 performs the necessary operations for failing over or performing a switchover from the primary application instance to an associated replica application instance. For example, the replica application failover module 540 may reset an indicator that indicates whether or not the replica application instance is operating in a replica mode or a primary application instance mode. Based on this resetting of the indicator to indicate that the replica application instance is now operating as a primary application instance, filtration of outbound communications may be disabled and the performance of system calls with their associated returned data may be enabled.

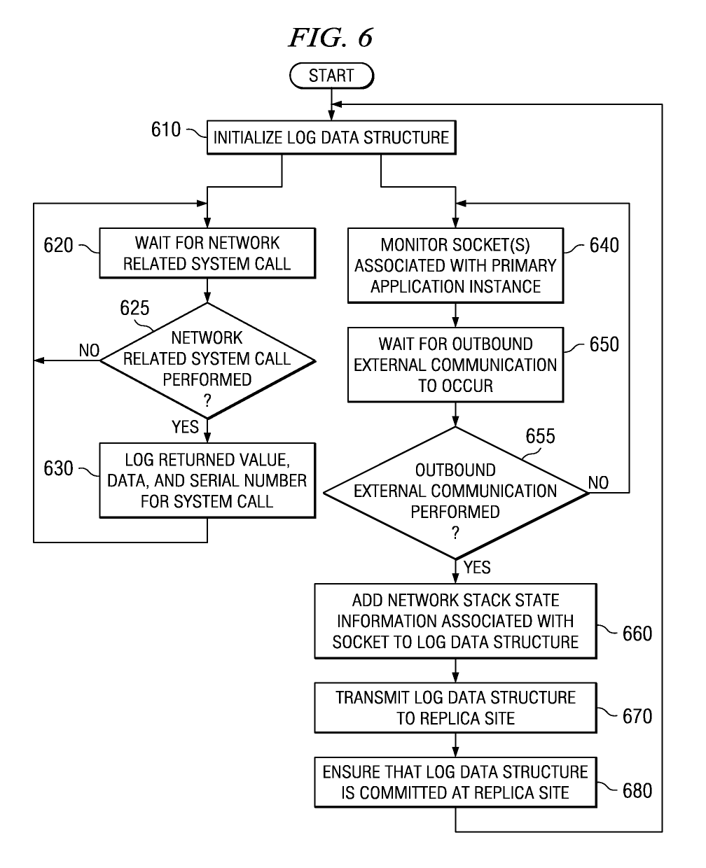

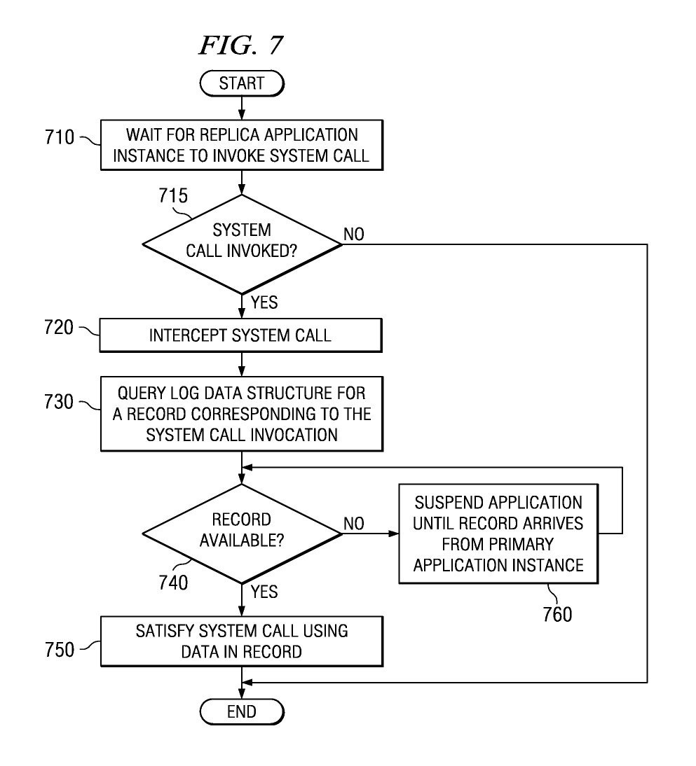

FIGS. 6 and 7 are flowcharts outlining exemplary operations of data processing devices in accordance with one illustrative embodiment. It will be understood that each block of the flowchart illustrations, and combinations of blocks in the flowchart illustrations, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or by combinations of special purpose hardware and computer instructions.

FIG. 6 is a flowchart outlining an exemplary operation of a primary fault tolerance engine in accordance with one illustrative embodiment. As shown in FIG. 6, the operation starts by initializing a log data structure associated with a primary application instance (step 610). The operation then branches into two separate threads of operation, a first “producer” thread and a second “consumer” thread. These threads of operation may operate at substantially a same time within the primary fault tolerance engine.

For the “producer” thread, the primary fault tolerance engine waits for a primary application instance to invoke a network related system call (step 620). If a network related system call occurs, the returned value and data for that system call along with a serial number are logged (step 630). The operation then returns to step 620 and waits for the next network related system call.

For the “consumer” thread, the primary fault tolerance engine monitors one or more sockets associated with the primary application instance (step 640) and waits for an outbound external communication to occur (step 650). If an outbound external communication occurs, the network stack state information associated with the socket is added to the log data structure (step 660) and the log data structure is transmitted to the replica site (step 670). The primary fault tolerance engine then ensures that the log data structure is committed at the replica site (step 680), for example by performing an acknowledgment or non-acknowledgment based commit operation. The operation then returns to step 610.

The operation outlined in FIG. 6 may be repeated until a termination event occurs. Such a termination event may occur, for example, in response to a failure of the primary application instance, a specific discontinuing of the operation of the illustrative embodiment, or any other implementation specific event.

FIG. 7 is a flowchart outlining an exemplary operation of a replica fault tolerance engine in accordance with one illustrative embodiment. As shown in FIG. 7, the operation starts with the replica fault tolerance engine waiting for the replica application instance to invoke a system call (step 710). If a system call occurs, the replica fault tolerance engine intercepts a system call by the replica application instance (step 720). The replica fault tolerance engine then queries the log data structure for a record corresponding to the system call invocation (step 730).

A determination is made as to whether the record corresponding to the system call invocation is available (step 740). If the record corresponding to the system call invocation is available in the log data structure, the system call invocation is satisfied using the content in the record, e.g., the returned data logged in the record is returned to the replica application instance as the result of the system call invocation (step 750). If the record is not available in the log data structure, the application is suspended until the record arrives from the primary application instance's log data structure (step 760). The operation then returns to step 740.

The operation outlined in FIG. 7 may be repeated until a termination event occurs. Such a termination event may occur, for example, in response to a failure of the primary application instance and a switchover to the replication application instance, a specific discontinuing of the operation of the illustrative embodiment, or any other implementation specific event.

Thus, the illustrative embodiments provide a mechanism by which failover of a primary application instance to a replica application instance is made transparent. This transparency is facilitated by the updating of network state information at the replica application instance based on logged system call return data and logged network state information associated with outgoing external communications of a primary application instance.

The logged information is provided to the replica application instance in response to the primary application instance performing an outbound external communication. Preferably, the logged information is provided to the replica application instance just prior to the outbound external communication occurring, or at substantially a same time as the outbound external communication. The information logged is concerned only with the network state of the primary application instance that is perceivable by an external network or network attached devices and thus, not all network state information needs to be logged by the mechanisms of the illustrative embodiments.

It should be appreciated that the illustrative embodiments may take the form of an entirely hardware embodiment, an entirely software embodiment or an embodiment containing both hardware and software elements. In one exemplary embodiment, the mechanisms of the illustrative embodiments are implemented in software, which includes but is not limited to firmware, resident software, microcode, etc.

Furthermore, the illustrative embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer program product comprising a computer useable medium having computer executable instructions embodied therein, wherein the computer executable instructions, when executed in a data processing system, cause the data processing system to:
initialize a log data structure associated with a primary application instance running on a first computing device;
log network state information associated with the primary application instance in the log data structure;
detect an outgoing external communication from the primary application instance to one or more external devices external to the first computing device; and
transmit, in response to detecting the outgoing external communication, the logged network state information from the first computing device to a second computing device running a replica application instance, wherein, in the event of a failure of the primary application instance, the replica application instance recovers for the primary application instance using a replica application instance network state made consistent with a network state of the primary application instance prior to the failure, based on the logged network state information.

2. The computer program product of claim 1, wherein the network state information logged in the log data structure comprises only network state information required to make a network state of the replica application instance consistent with a network state of the primary application instance communicated to one or more external devices, and wherein other network state information, associated with a network stack of the primary application instance, that is not communicated to the one or more external devices is not logged in the log data structure.

3. The computer program product of claim 1, wherein the logged network state information comprises data returned in response to one or more network state associated system calls by the primary application instance.

4. The computer program product of claim 1, wherein the logged network state information comprises cumulative network state information recorded from a point in time of a previous outbound external communication up to a point in time where a current outbound external communication is to be performed by the primary application instance.

5. The computer program product of claim 1, wherein the computer executable instructions cause the data processing system to log network state information by:
logging data returned by network state associated system calls in the log data structure until the outbound external communication is detected at the socket of the primary application instance; and
in response to detecting the outbound external communication at the socket of the primary application instance, logging network stack state information associated with the socket of the primary application instance.

6. The computer program product of claim 1, wherein the computer executable instructions cause the data processing system to transmit the logged network state information by:
transmitting the log data structure to the second computing device either prior to permitting the outbound external communication to occur or at substantially a same time as the outbound external communication occurs.

7. The computer program product of claim 1, wherein the computer executable instructions further cause the data processing system to:
receive, at the second computing device, the logged network state information from the first computing device; and
update a network state of the replica application instance based on the logged network state information received from the first computing device such that the network state of the replica application instance is consistent with a network state of the primary application instance communicated to the one or more external devices, in order to provide transparent recovery of the primary application instance by the replica application instance.

8. The computer program product of claim 1, wherein the computer executable instructions further cause the data processing system to:
intercept, by the second computing device, system calls invoked by the replica application instance; and
satisfy the invoked system calls using data provided in the logged network state information received from the first computing device, the data being associated with corresponding system calls invoked by the primary application instance.

9. The computer program product of claim 8, wherein the computer executable instructions further cause the data processing system to:
detect a failure of the primary application instance; and
perform a switchover operation to switchover handling of requests by the one or more external devices to the replica application instance in response to detecting the failure of the primary application instance, wherein by virtue of satisfying the invoked system calls using data provided in the logged network state information received from the first computing device, the replica application instance has a network state consistent with the network state of the primary application instance communicated to the one or more external devices.

10. A computer program product comprising a computer useable medium having computer executable instructions embodied therein, wherein the computer executable instructions, when executed in a data processing system, cause the data processing system to:
receive, from a computing device executing a primary application instance, a log data structure, the log data structure storing only network state information required to make a network state of a replica application instance consistent with a network state of the primary application instance communicated to one or more external devices;
update a network state of the replica application instance based on the network state information in the log data structure; and
recover for the primary application instance in the event of a failure of the primary application instance, wherein at the time of failure, the network state of replica application instance is consistent with the network state of the primary application instance communicated to the one or more external devices by way of the updating of the network state of the replica application instance based on the network state information in the log data structure.

11. A method for replication a network state of a primary application instance, running on a first computing device, at a replica application instance running on a second computing device, comprising:
initializing a log data structure associated with the primary application instance running on the first computing device;
logging network state information associated with the primary application instance in the log data structure;
detecting an outgoing external communication from the primary application instance to one or more external devices external to the first computing device; and
transmitting, in response to detecting the outgoing external communication, the logged network state information from the first computing device to the second computing device running the replica application instance, wherein, in the event of a failure of the primary application instance, the replica application instance recovers for the primary application instance using a replica application instance network state made consistent with a network state of the primary application instance prior to the failure, based on the logged network state information.

12. The method of claim 11, wherein the network state information logged in the log data structure comprises only network state information required to make a network state of the replica application instance consistent with a network state of the primary application instance communicated to one or more external devices, and wherein other network state information, associated with a network stack of the primary application instance, that is not communicated to the one or more external devices is not logged in the log data structure.

13. The method of claim 11, wherein the logged network state information comprises data returned in response to one or more network state associated system calls by the primary application instance.

14. The method of claim 11, wherein the logged network state information comprises cumulative network state information recorded from a point in time of a previous outbound external communication up to a point in time where a current outbound external communication is to be performed by the primary application instance.

15. The method of claim 11, wherein logging network state information comprises:
logging data returned by network state associated system calls in the log data structure until the outbound external communication is detected at the socket of the primary application instance; and
in response to detecting the outbound external communication at the socket of the primary application instance, logging network stack state information associated with the socket of the primary application instance.

16. The method of claim 11, wherein transmitting the logged network state information comprises:
transmitting the log data structure to the second computing device either prior to permitting the outbound external communication to occur or at substantially a same time as the outbound external communication occurs.

17. The method of claim 11, further comprising:
receiving, at the second computing device, the logged network state information from the first computing device; and
updating a network state of the replica application instance based on the logged network state information received from the first computing device such that the network state of the replica application instance is consistent with a network state of the primary application instance communicated to the one or more external devices, in order to provide transparent recovery of the primary application instance by the replica application instance.

18. The method of claim 11, further comprising:
intercepting, by the second computing device, system calls invoked by the replica application instance; and
satisfying the invoked system calls using data provided in the logged network state information received from the first computing device, the data being associated with corresponding system calls invoked by the primary application instance.

19. The method of claim 18, further comprising:
detecting a failure of the primary application instance; and
performing a switchover operation to switchover handling of requests by the one or more external devices to the replica application instance in response to detecting the failure of the primary application instance, wherein by virtue of satisfying the invoked system calls using data provided in the logged network state information received from the first computing device, the replica application instance has a network state consistent with the network state of the primary application instance communicated to the one or more external devices.

20. An apparatus, comprising:
a processor; and
a memory coupled to the processor, wherein the memory comprises instructions which, when executed by the processor, cause the processor to:
initialize a log data structure associated with a primary application instance running on the apparatus;
log network state information associated with the primary application instance in the log data structure;
detect an outgoing external communication from the primary application instance to one or more external devices external to the apparatus; and
transmit, in response to detecting the outgoing external communication, the logged network state information from the apparatus to a computing device running a replica application instance, wherein, in the event of a failure of the primary application instance, the replica application instance recovers for the primary application instance using a replica application instance network state made consistent with a network state of the primary application instance prior to the failure, based on the logged network state information.
